(19) United States
(12) Patent Application Publication
(10) Pub. No.: US 2010/0227023 A1
(43) Pub. Date: Sep. 9, 2010

(54) SEASONING BLEND

(75) Inventors: John Wassergord, New Century, KS (US); Thomas Rourke, New Century, KS (US)

Correspondence Address: SCULLY SCOTT MURPHY & PRESSER, PC, 400 GARDEN CITY PLAZA, SUITE 300, GARDEN CITY, NY, 11530, US

(73) Assignee: Danisco A/S, Copenhagen (DK)

(21) Appl. No.: 12/399,246

(22) Filed: Mar. 6, 2009

(51) Int. Cl. A23L 1/237; A23L 1/22

(52) U.S. Cl. 426/74; 426/649

(57) ABSTRACT

The present invention relates to a seasoning blend and/or a seasoning mixture containing betaine and sodium chloride, potassium chloride, a magnesium salt, green tea extract, and/or lysine. The present invention also relates to a method of seasoning a food ingredient and/or a food product with the seasoning blend and/or mixture containing betaine and sodium chloride, potassium chloride, a magnesium salt, green tea extract, and/or lysine. Further, the present invention relates to a use of the seasoning blend and/or mixture in reducing the content of sodium in a food ingredient and/or a food product.

### FIELD OF THE INVENTION

The present invention relates to a seasoning blend, a seasoning mixture and a method of seasoning a food ingredient and/or a food product. Particularly, the present invention relates to a seasoning blend and/or a seasoning mixture that contains betaine. The present invention also relates to a method of seasoning a food ingredient and/or a food product with the seasoning blend and/or mixture containing betaine. Further, the present invention relates to a use of betaine in reducing the content of sodium in a food ingredient and/a food product.

### BACKGROUND OF THE INVENTION

Common salt, sodium hydrochloride, is the most general source of sodium in humans. Health issues with respect to high sodium intake have increased, causing a need for the development of salt replacement systems. Consumers are constantly looking to reduce their salt intake as more and more evidence has linked sodium consumption to health problems, such as hypertension, high blood pressure, and cardiovascular disease.

The Finnish Patent No. 60107 describes a salt composition containing from 50 to 65 weight-% sodium chloride, from 20 to 40 weight-% potassium chloride and from 5 to 20 weight-% magnesium chloride or magnesium sulphate.

In Japan Food Science (1989) 11; 38-42, it is disclosed that betaine has been used to improve the taste of processed food, especially marine based products. Further, it was found that betaine does not affect the salty taste of salt and it strengthens the sweetness of betaine (itself) only, not sweetness of sugar, alanine or glycine.

Patent publication U.S. Pat. No. 6,217,930 discloses that addition of betaine in the baked good enhances flavor of the good and that baked goods containing betaine have a smoother mouthfeel and softness relative to baked products without betaine.

According to patent publication US 2003/0091615 betaine enhances the flavor of a beverage, such as diet soda containing artificial sweeteners, an isotonic drink, 15% juice smoothie and instant coffee. Betaine also smoothed the notes of bitterness of the artificial sweetener in the diet soda.

Consumers desire low sodium foods without sacrificing flavor of salt. It is thus important to reduce sodium levels in foods and at the same time to maintain the flavor properties of the foods.

The present invention now provides a novel manner for salt replacement.

### BRIEF DESCRIPTION OF THE INVENTION

The present invention relates to a seasoning blend comprising betaine and at least one of sodium chloride, potassium chloride, a magnesium salt, green tea extract, and/or lysine. Further, the present invention relates to a seasoning mixture consisting of betaine and at least one of sodium chloride, potassium chloride, a magnesium salt, green tea extract, and/or lysine.

The present invention relates also to a method for seasoning a food ingredient and/or a food product with the blend comprising betaine and at least one of sodium chloride, potassium chloride, a magnesium salt, green tea extract, and/or lysine. Further, the present invention relates to method for seasoning a food ingredient and/or a food product with the mixture consisting of betaine and at least one of sodium chloride, potassium chloride, a magnesium salt, green tea extract, and/or lysine. The present invention relates to a use of the seasoning blend and/or mixture in reducing the content of sodium in a food ingredient and/a food product.

Further, the present invention relates to a method for reducing the content of sodium in a food ingredient and/or a food product by using the seasoning blend or mixture of the invention in the preparation of the food ingredient or food product.

In addition, the present invention relates to a use of betaine in reducing the content of sodium in a seasoning blend, a seasoning mixture, a food ingredient and/or a food product. The present invention still relates to a method of reducing the content of sodium in a seasoning blend, a seasoning mixture, a food ingredient and/or a food product by using an efficient amount of betaine in the preparation of the seasoning blend, seasoning mixture, food ingredient or food product.

The seasoning blend and mixture of the invention create options for people looking to lower their sodium consumption without a severe loss in flavor of the food items. The blend and mixture of the invention have the ability to maintain or enhance the flavor profile of a food product while reducing the sodium content up to 50%. The seasoning blend and/or mixture of the invention can be incorporated into various food products and food systems including soups, sauces, such as tomato sauce, dressings, processed meat products, such as, sausages, cured products, emulsified meats, deli meats, bakery products, dairy products, spreads and margarines.

The use of the seasoning blend and/mixture of the invention in processed foods allows a salt reduction of approximately 25 to 50% without sacrificing the desirable salt flavor.

The objects of the invention are achieved by the blend, mixture, method and use set forth in the independent claims. Preferred embodiments of the invention are described in the dependent claims.

Other objects, details and advantages of the present invention will become apparent from the following detailed description and examples.

### DETAILED DESCRIPTION OF THE INVENTION

Health issues relating to high blood pressure and hypertension have caused the use of common salt and accordingly sodium content in foodstuff to be scrutinized. In many different food ingredients and/or products, the objective is to find a salt replacement option in order to rectify these health issues.

In the present invention betaine refers to trimethylglycine. The compound is also called trimethylammonioacetate, 1-carboxy-N,N,N-trimethylmethaneaminium, inner salt and glycine betaine. It is a naturally occuring quaternary ammonium type compound having the formula

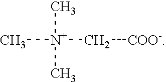

Betaine has a bipolar structure comprising a hydrophilic moiety (COO⁻) and a hydrophobic moiety (N⁺) capable of neutralizing both acid and alkaline solutions.

In its pure form, betaine is a white crystalline compound that is readily soluble in water and lower alcohols. In the present invention betaine can be used, for example, as anhydrous form, or as a monohydrate or a salt, such as betaine hydrochloride. Betaine is commercially available from Finnfeeds Finland Oy as an anhydrous form and also as a monohydrate. It is sold under the tradename Betafin, which includes a range of highly purified betaine products.

In the present invention, sodium chloride refers to a chemical compound with the formula NaCl, that is also known as common salt or table salt.

In the present invention, potassium chloride refers to a chemical compound with the formula KCl. Potassium is a nutrient that helps to lower blood pressure; prevent bone loss and reduce the risk of developing kidney stones.

In the present invention, a magnesium salt refers to magnesium chloride MgCl₂ and its various hydrates MgCl₂(H₂O)ₓ, magnesium sulphate MgSO₄ and/or magnesium oxide MgO.

In the present invention, lysine refers to lysine hydrochloride and/or lysine, preferably to L-lysine. L-lysine is an essential amino acid that must be supplied by diet.

Green tea extract is known as a natural antioxidant and as a natural flavoring. Green tea is traditionally used mostly in beverages. Green tea extract is commercially available from Danisco A/S under the tradename GUARDIAN™ Green Tea Extracts.

In the present invention, the terms “seasoning mixture” and “seasoning blend” refer to seasoner compositions used to flavor food ingredients and/or food products.

In the present invention, the term “food ingredient” refers to a composition or an intermediate product, such as a salt replacement composition or a salt substitute, that is employed in the preparation of an edible food product.

In the present invention, the term “food product” refers to edible nutritional product or foodstuff eaten by the consumers such as a soup, sauce, dressing, meat product, dairy product, spread and margarine.

In one aspect, the present invention is based on the finding that sodium can be replaced, at least partly, by betaine and accordingly, sodium content of an edible product can be reduced. It is thus, the object of the present invention to provide a seasoning blend and a seasoning mixture with reduced sodium content and a method of seasoning a food ingredient and/or a food product to reduce the sodium portion the consumers receives by eating this food item. In one embodiment of the invention, the seasoning blend and/or mixture are formulated into a salt substitute or salt replacement composition.

Further, the present invention relates to use of the seasoning blend and/or the seasoning mixture to reduce the sodium content of a food ingredient and/or a food product. Additionally, the present invention relates to use of betaine to reduce the sodium content of a food ingredient, food product, seasoning blend and/or seasoning mixture.

The method of the present invention comprises seasoning a food ingredient and/or a food product with the seasoning blend and/or mixture containing betaine and at least one of sodium chloride, potassium chloride, a magnesium salt, green tea extract and/or lysine. Another method of the present invention comprises reducing the content of sodium in a food ingredient and/or a food product by using the seasoning blend and/or mixture containing betaine and at least one of sodium chloride, potassium chloride, a magnesium salt, green tea extract, and/or lysine in the preparation. Further, the present invention relates to a use of the seasoning blend and/or mixture in reducing the content of sodium in a food ingredient and/or a food product.

The seasoning blend of the present invention comprises betaine and at least one of sodium chloride, potassium chloride, a magnesium salt, green tea extract and/or lysine. The seasoning mixture of the present invention consists of betaine and at least one of sodium chloride, potassium chloride, a magnesium salt, green tea extract and/or lysine. The seasoning blend and/or seasoning mixture of the present invention may contain varying amounts or percentages of these ingredients. The amount of betaine in the blend or mixture is typically from 5 to 95 weight-% based on the total weight of the blend or the mixture.

The seasoning blend of the present invention may also contain additional ingredients and/or additives typical for seasoning blends. Examples of such components are bulking agents, anticaking agents, preservatives, colors, flavors, spices and herbs.

In one embodiment of the invention, the seasoning blend or mixture of the present invention contains betaine and one of sodium chloride, potassium chloride, a magnesium salt, green tea extract or lysine. Specific applications of this embodiment are blends and mixtures containing betaine and potassium chloride or green tea extract where the amount of betaine typically varies between 30 to 95 weight-%, specifically from 40 to 93 weight-% based on the total weight of the blend or mixture. The amount of potassium typically varies between 10 and 70 weight-%, specifically from 30 to 60 weight-%, and the amount of green tea extract varies between 5 and 30 weight-%, specifically from 5 to 15 weight-%, based on the total weight of the blend or mixture. In one preferred embodiment, the seasoning blend or mixture contains betaine from 40 to 70 weight-% and potassium chloride from 30 to 60 weight-% based on the total weight of the blend or mixture.

In another embodiment of the invention, the seasoning blend or mixture of the present invention contain betaine and at least two of sodium chloride potassium chloride, a magnesium salt, green tea extract, or lysine. Specific application of this embodiment are blends and mixtures containing betaine and potassium chloride and green tea extract where the amount of betaine typically varies between 40 to 80 weight-%, the amount of potassium typically varies between 10 to 50 weight-% and the amount of green tea extract between 5 to 30 weight-%, based on the total weight of the blend or mixture. A further application of this embodiment is blends or mixtures containing betaine, sodium chloride and potassium chloride. The proportions of sodium chloride, potassium chloride and betaine in the blend and/or mixture may vary. The amount of sodium chloride in the blend and/or mixture varies in the range of 30 to 70% (w/w). The amount of potassium chloride in the mixture varies in the range of 5 to 60% (w/w) and the amount of betaine in the blend and/or mixture varies in the range of 20 to 40% (w/w). Preferred blends and/or mixtures contain 60:20:20% (w/w), 50:30:20% (w/w), 70:10:20% (w/w), 70:5:25% (w/w), 40:40:20% (w/w), 50:20:30% (w/w), 40:30:30% (w/w), 40:20:40% (w/w), 30:30:40% (w/w) sodium chloride, potassium chloride and betaine, respectively. The most preferred blend and/or mixtures contain 50:30:20% (w/w) or 40:40:20% (w/w) sodium chloride, potassium chloride and betaine, respectively.

In yet another embodiment of the invention, the seasoning blend or mixture contains betaine, sodium chloride and at least one of potassium chloride, a magnesium salt, green tea extract, and/or lysine. The proportions of betaine, sodium chloride and at least one of potassium chloride, a magnesium salt, green tea extract, and/or lysine in the blend and/or mixture may vary. The amount of sodium chloride varies typically in the range of 30 to 70% (w/w) and the amount of betaine varies typically in the range of 20 to 40% (w/w) in the blend and/or mixture.

The blend and/or mixture of the present invention, such as, blends and/or mixtures containing 50:30:20% (w/w) and 40:40:20% (w/w) sodium chloride, potassium chloride and betaine, respectively, blends and/or mixtures containing betaine and potassium chloride 70,30% and 40:60% (w/w) or betaine and green tea extract 93:7% (w/w); were found to show advantageous properties in various food products like processed meat products, soups, sauces, dressings and dairy and bakery products.

The blend and/or mixture of the present invention, such as, blends and/or mixtures containing 50:30:20% (w/w) and 40:40:20% (w/w) sodium chloride, potassium chloride and betain, respectively, functioned very well at a reduction level of 25-35%, and had effectiveness in a reduction up to 40% or even to 50% of sodium.

The seasoning blend and/or mixture of the present invention provide a useful means for consumers to reduce the daily nutritional supply of sodium. Especially, the seasoning blend and/or mixture of the present invention provide a label friendly system to help in sodium reduction to the food industry. The blend and/or mixture can be used in various food products including soups, sauces, dressings, meat products, bakery products, breakfast cereal, savory snacks and crisps, dairy products, margarines and spreads, such as, low fat spreads.

Salt is a problem facing all food categories due to the negative health effects of high sodium contents. Reducing sodium in a food product is very difficult from a flavor and also a functional point of view. Sodium is used in meat systems not only for flavor enhancement, but also for the binding of water and extraction of proteins. In other application areas, salt is used as a flavor enhancement product as well as a microbial hurdle. The blend and/or mixture of the present invention not only has flavor enhancement properties, but has also functional properties due to the characteristics of betaine and the other constituents individually and/or in combination in the blend and/or mixture. The present blend and/or mixture show benefits as opposed to current market offerings, such as enhanced muscle protein extraction in meat products and extraction of wheat proteins in bakery products. In addition, betaine masks the poor flavor of KCl that is included to assist the previously mentioned protein extractions.

Thus, the seasoning blend and/or mixture of the present invention can be used as a salt replacement system and/or as a salt substitute in various food ingredients and food products in the industry as well as in private home applications. In addition, the seasoning mixture of the present invention has advantageous effects on the indigenous flavor of various food ingredients and food products. Even further, the seasoning mixture of the present invention provides functional effects, such as, protein extraction, water binding, cook yield enhancement, microbial inhibition, on various food ingredients and food products.

The blend and/or mixture of the present invention, when used as a one for one replacement for salt, taste less salty than the full or common salt formulations. However, the blend and/or mixture of the present invention enhance other flavors within the food ingredient and/or food product.

The following examples illustrate the present invention. The examples are not to be construed to limit the claims in any manner whatsoever.

### EXAMPLE 1

The mixtures containing different proportions of sodium chloride, potassium chloride and betaine were manufactured by dry blending the ingredients in order to form the mixture. The different mixtures prepared are shown in Table 1.

TABLE 1

| | % | * | | | * | | | | |
|---|---|---|---|---|---|---|---|---|---|
| Ingredients | Mix. 1 | Mix. 2 | Mix. 3 | Mix. 4 | Mix. 5 | Mix. 6 | Mix. 7 | Mix. 8 | Mix. 9 |
| Sodium | 60 | 50 | 70 | 70 | 40 | 50 | 40 | 40 | 30 |
| Chloride | | | | | | | | | |
| Potassium | 20 | 30 | 10 | 5 | 40 | 20 | 30 | 20 | 30 |
| Chloride | | | | | | | | | |
| Betaine | 20 | 20 | 20 | 25 | 20 | 30 | 30 | 40 | 40 |
| (Betafin ®) | | | | | | | | | |

Betafin is a trademark of Danisco A/S

### EXAMPLE 2

### Reduced Solids Tomato Sauce

Salt and mixtures 1 to 4 were post-added at a level of 0.90% to Reduced Solids Tomato Sauce. The sauce products were then allowed to rest for a day in order for the flavors to meld. The mixture with 50% sodium chloride, 30% potassium chloride and 20% betaine performed the best of the tested mixtures 1 to 4. Its saltiness level matched that of the pure salt, but gained an added flavor bonus.

### EXAMPLE 3

### Broccoli and Cheese Soup

The soup was first made with a 35% reduction of 1% salt to 0.65% salt The mixtures 1 to 4 were post-added at a rati that equalled the 35% reduction of the salt. The blend chosen as the most effective in the tomato sauce was also chosen to be the most effective in this application, giving the saltiest taste and the best flavor. The soup was again made without any

In order to optimize the effects of the ingredients of the mixture, mixtures 5 to 9 shown in Table 1 were also tested in this application. These mixtures were post-added to the soup. The formula with 40% sodium chloride, 40% potassium chloride, and 20% betaine was found to be about equal in effect to mixture 2.

Salt and the mixtures were each added in separate batches during processing at levels of 0.65%. Mixtures 2 and 5 were added at a level to achieve a 40% sodium reduction when compared with the salt control. An untrained panel of 10 members blindly tasted the two samples. All panellists stated the control soup salted with common salt was saltier than the sample seasoned with the mixtures 2 and 5. However in overall preference, the seasoning of the mixtures 2 and 5 were chosen better.

### EXAMPLE 4

### Hamburgers

Mixture 2 was added to ground beef in order to make hamburger patties. The meat contained 20% fat and had no other additions besides salt and the mixture 2, respectively. The control contained 1% salt, the test sample contained mixture 2 at a level of 1%. The patties were made and refrigerated for 24 hours before they were cooked and tasted. An untrained sensory panel of 7 members blindly tasted the two samples. All seven panelists stated that the control formulation was saltier, but six of these seven chose the sample seasoned with the mixture 2 as the most preferred.

### EXAMPLE 5

Mixtures containing different proportions of betaine and potassium chloride were manufactured by dry blending the ingredients in order to form the mixture. The mixtures prepared are shown in Table 2.

TABLE 2

| | % | * | | | * | |
|---|---|---|---|---|---|---|
| Ingredients | Mix. 1 | Mix. 2 | Mix. 3 | Mix. 4 | Mix. 5 | Mix. 6 |
| Potassium | 10 | 20 | 30 | 40 | 50 | 60 |
| Chloride | | | | | | |
| Betaine | 90 | 80 | 70 | 60 | 50 | 40 |
| (Betafin ®) | | | | | | |

Betafin is a trademark of Danisco A/S

Especially, mixtures 3 and 6 were found to show advantageous properties in various food products.

### EXAMPLE 6

Mixtures containing different proportions of betaine and green tea extract were manufactured by dry blending the ingredients in order to form the mixture. The mixtures prepared are shown in Table 3.

TABLE 3

| | % | | | | | |
|---|---|---|---|---|---|---|
| Ingredients | Mix. 1 | Mix. 2 | Mix. 3 | Mix. 4 | Mix. 5 | Mix. 6 |
| Green tea | 5 | 7 | 10 | 20 | 30 | 40 |
| extract | | | | | | |
| (Guardlan ™ | | | | | | |
| Green Tea | | | | | | |
| Extract) | | | | | | |
| Betaine | 95 | 93 | 90 | 80 | 70 | 60 |
| (Betafin ®) | | | | | | |

Betafin and Guardian ™ Green Tea Extract are trademarks of Danisco A/S

Especially, mixture 2 was found to have advantageous properties in various food products

It will be obvious to a person skilled in the art that, as the technology advances, the inventive concept can be implemented in various ways. The invention and its embodiments are not limited to the examples described above but may vary within the scope of the claims.

1. A seasoning blend comprising betaine and at least one of sodium chloride, potassium chloride, a magnesium salt, green tea extract, and/or lysine.

2. A seasoning mixture consisting of betaine and at least one of sodium chloride, potassium chloride, a magnesium salt, green tea extract, and/or lysine.

3. The seasoning blend or mixture according to claim 1 or claim 2, containing betaine, sodium chloride and at least one of potassium chloride, a magnesium salt, green tea extract, and/or lysine.

4. The seasoning blend or mixture according to any one of claims 1 to 3, containing sodium chloride in the range of 30 to 70% (w/w), potassium chloride in the range of 5 to 40% (w/w) and betaine in the range of 20 to 40%. (w/w).

5. The seasoning blend or mixture according to claim 4, containing 60:20:20% (w/w), 50:30:20% (w/w), 70:10:20% (w/w), 70:5:25% (w/w), 40:40:20% (w/w), 50:20:30% (w/w), 40:30:30% (w/w), 40:20:40% (w/w) or 30:30,40% (w/w) sodium chloride, potassium chloride and betaine, respectively.

6. The seasoning blend or mixture according to claim 1 or claim 2, containing betaine and potassium chloride, and/or green tea extract.

7. The seasoning blend or mixture according to claim 6 containing betaine from 40 to 95 weight-%, potassium chloride from 10 to 70 weight-%, and/or green tea extract from 5 to 30 weight-%.

8. A method for seasoning a food ingredient and/or a food product by adding the seasoning blend or mixture according to any one of claims 1 to 7 to the ingredient and/or product.

9. A method according to claim 8 wherein a food product is a soup, sauce, dressing, meat product, bakery product, breakfast cereal, savoury snacks and crisps, dairy product, margarine or spread.

10. A method for reducing the content of sodium in a food ingredient and/or a food product by using the seasoning blend or mixture according to any one of claims 1 to 7 in the preparation of the ingredient and/or product.

11. A method according to claim 10 wherein a food product is a soup, sauce, dressing, meat product, bakery product, breakfast cereal, savoury snacks and crisps, dairy product, margarine or spread.

12. The method according to claim 10 or claim 11 wherein a reduction up to 50% of the sodium content is achieved.

13. A use of the seasoning blend or mixture according to any one of claims 1 to 7 in reducing the content of sodium in a food ingredient and/or a food product.

14. The use according to claim 13 wherein a food product is a soup, sauce, dressing, meat product, bakery product, breakfast cereal, savoury snacks and crisps, dairy product, margarine or spread.

15. The use according to claim 13 or claim 14 wherein a reduction up to 50% of the sodium content is achieved.

16. A method for reducing the content of sodium in a seasoning blend, seasoning mixture, food ingredient and/or a food product by using betaine in the preparation of said blend, mixture, ingredient and/or product.

17. A use of betaine in reducing the content of sodium in a seasoning blend, a seasoning mixture, a food ingredient and/or a food product.
